(19) United States
(12) Patent Application Publication
(10) Pub. No.: US 2016/0379422 A1
(43) Pub. Date: Dec. 29, 2016

(54) SYSTEMS AND METHODS FOR DISPLAYING VEHICLE INFORMATION WITH SEE-THROUGH EFFECT

(71) Applicant: William C. Kahn, Denton, TX (US)

(72) Inventor: William C. Kahn, Denton, TX (US)

(73) Assignee: PACCAR Inc, Seattle, WA (US)

(21) Appl. No.: 14/751,799

(22) Filed: Jun. 26, 2015

(51) Int. Cl. G07C 5/08; B60R 1/00; B60K 35/00

(52) U.S. Cl. CPC G07C 5/0825; B60K 35/00; B60R 1/00; B60K 2350/106; B60K 2350/965

(57) ABSTRACT

A display system suitable for use in a vehicle is set forth. The display system comprises a smart device, such as a cellular phone, tablet, smart display or the like, that is configured to display one or more types of vehicle information while at the same time diminishing any visual impairment caused by the device to the driver.

### BACKGROUND

In transportation, it is desirable to have information instantaneously available to monitor the functions of the moving vehicle. Present methodologies include dashboard display units such as speedometers, odometers, fuel gauges, engine temperature gauges, transmission function and the like, often with illuminated dials. More recent methodologies, sometimes referred to as Head Up Displays (“HUDs”), cause one or more of these functions to be displayed on a windshield or a similar transparent screen. Typically, the position of display is in the eyesight directly in front of the driver, so that in driving a vehicle, the driver is able to view directly the vehicle driving speed or other data she desires to know, without the need to raise or lower her head to change her field of view.

In one conventional HUD device, the vehicle information to be displayed is first projected by an optical device onto a display screen that is placed inside the wind shield and facing the wind shield. Then, the vehicle information displayed on the display screen is reflected by the wind shield and displayed on the wind shield for viewing by the driver.

With such a device, the associated hardware is quite large, requiring a voluminous space in the instrument panel to house all of the components. Accordingly, there is a need in the industry, among others, to provide HUD capabilities to vehicles that have minimal space available in the instrument panel.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In accordance with an aspect of the present disclosure, a method is carried out in a vehicle having a graphical display. The method is implemented in computer-executable instructions for displaying information about the vehicle. The method comprises obtaining view data from a camera, the view data indicative of a field of view of an operator when operating the vehicle, obtaining vehicle data, and causing the graphical display to render the vehicle data and the view data in an overlaying manner.

In accordance with another aspect of the present disclosure, a computer-readable medium is provided having modules for conveying information about a vehicle on a graphical display. The computer-readable medium includes an image acquisition module configured to collect data from a camera associated with a field of view of a driver of the vehicle, a graphical element rendering module configured to collect vehicle information from one or more information components and to generate one or more graphical elements representative of the collected vehicle data, a superimpose module configured generate a data stream composed of one or more of the generated graphical elements superimposed onto to the data collected from the camera, and a display module configured to cause the data stream to be presented to a graphical display for display.

In accordance with another embodiment of the present disclosure, a system is provided for providing information to a vehicle operator. The system includes a graphical display, a camera mounted in a suitable position so as to capture one or more images indicative of a field of view of a vehicle operator, and a display generator coupled to the camera and to the graphical display. The display generator in on embodiment is configured to: receive vehicle information from one or more information components: receive the one or more images captured by the camera; generate one or more graphical elements indicative of the vehicle information; generate a stream of data representing the one or more graphical elements superimposed onto the one or more images captured by the camera; and present the stream of data to the graphical display for display.

### DESCRIPTION OF THE DRAWINGS

The foregoing aspects and many of the attendant advantages of the claimed subject matter will become more readily appreciated as the same become better understood by reference to the following detailed description, when taken in conjunction with the accompanying drawings, wherein:

FIG. 1 illustrates a schematic representation of looking through a vehicle windshield from a driver's perspective;

FIG. 2 illustrates one representative example of a Heads Up Display (HUD) in accordance with an aspect of the present disclosure, the HUD associated with an area of the windshield in front of the driver;

FIG. 3 is a block diagram of one representative embodiment of the HUD of FIG. 2;

FIG. 4 is one representative embodiment of a display generator in accordance with an aspect of the present disclosure;

FIG. 5 is another representative embodiment of a display generator in accordance with an aspect of the present disclosure and

FIG. 6 is a flow diagram illustrating one method for displaying vehicle information in accordance with an aspect of the present disclosure.

### DETAILED DESCRIPTION

The detailed description set forth below in connection with the appended drawings, where like numerals reference like elements, is intended as a description of various embodiments of the disclosed subject matter and is not intended to represent the only embodiments. Each embodiment described in this disclosure is provided merely as an example or illustration and should not be construed as preferred or advantageous over other embodiments. The illustrative examples provided herein are not intended to be exhaustive or to limit the claimed subject matter to the precise forms disclosed.

The present disclosure relates to an inventive Heads Up Display (HUD) suitable for use in a vehicle. Instead of an image projected onto the windshield of the vehicle as is done by conventional HUDs, the HUD described herein comprises a smart device, such as a cellular phone, tablet, smart display or the like, that is configured to display one or more types of vehicle information while at the same time diminishing any visual impairment caused by the device to the driver.

Heretofore, the lack of space below the surface of a heavy truck's instrument panel restricts the use of any conventional HUD. Thus, previous solutions to this space problem have placed displays in the drivers field of view (e.g., A-pillar, back of sunvisor, etc.) to provide information to the driver. However, this limits the visibility outside the vehicle.

To address this problem and others, embodiments of the disclosure employ smart devices, such as a cellular phone, a tablet or smart display, etc., mounted in or otherwise associated with the field of view of the driver. In embodiments disclosed herein, the “smart” HUD can be mounted to the visor or windshield, suspended from the headliner, etc. The “smart” HUD is configured to communicate with one or more information generating or collecting components (“information components”). In one embodiment, the “smart” HUD is configured to communicate with the one or more information components via the truck's vehicle wide network, such as a CAN, in order to display to the driver such information as virtual gauges, diagnostics, truck-based applications, among others.

In order to solve the visibility issue for the driver, the “smart” HUD is equipped or associated with a forward facing camera, and is configured to act as a direct view display to the driver. In that regard, real-time video captured by the camera is displayed as the background of the vehicle information presented to the driver by the direct view display. In other words, vehicle information represented in any graphical form is superimposed on the real-time video acquired by the camera and presented together to the driver. This results in a “see through” effect in that the vehicle information on the display appears to be floating on the camera's captured real-time image/video as if the smart device is transparent.

In the following description, numerous specific details are set forth in order to provide a thorough understanding of one or more embodiments of the present disclosure. It will be apparent to one skilled in the art, however, that many embodiments of the present disclosure may be practiced without some or all of the specific details. In some instances, well-known process steps have not been described in detail in order to not unnecessarily obscure various aspects of the present disclosure. Further, it will be appreciated that embodiments of the present disclosure may employ any combination of features described herein.

Although representative embodiments of the present disclosure is described with reference to Class 8 trucks, it will be appreciated that aspects of the present disclosure have wide application, and therefore, may be suitable for use with many types of powered vehicles, such as passenger vehicles, buses, RVs, commercial vehicles, light and medium duty vehicles, and the like. Accordingly, the following descriptions and illustrations herein should be considered illustrative in nature, and thus, not limiting the scope of the claimed subject matter.

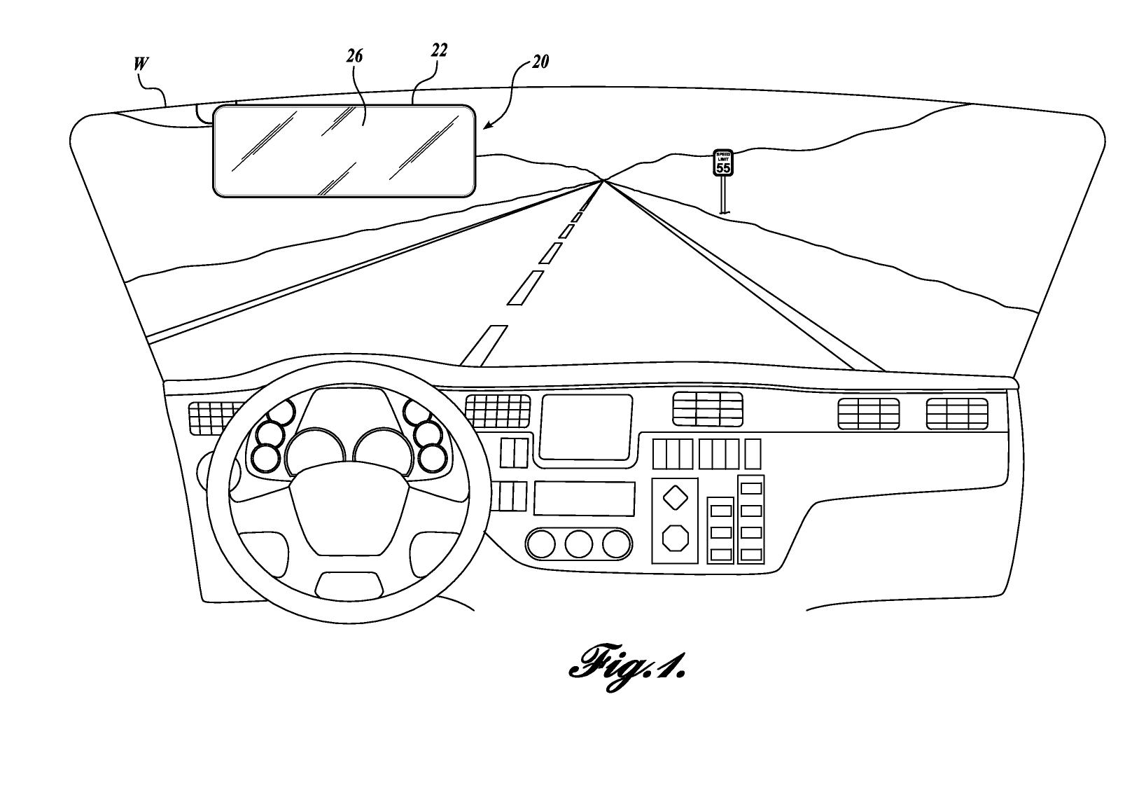

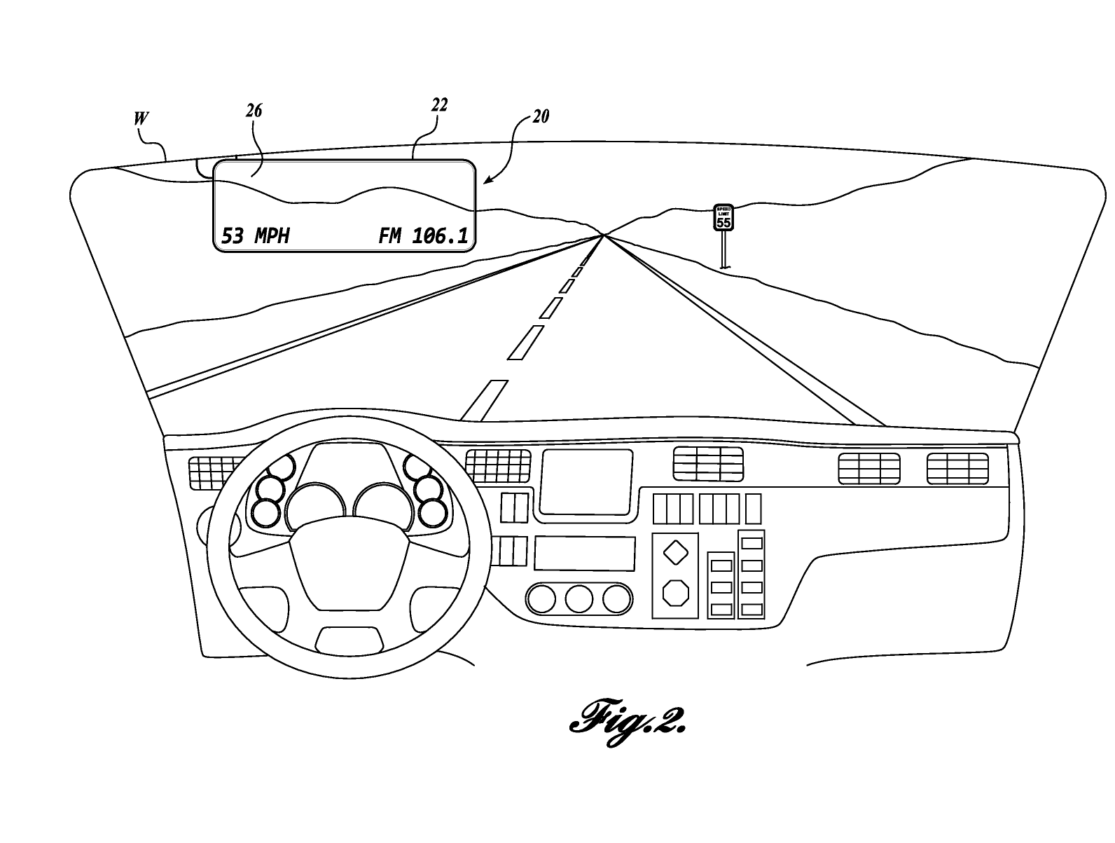

Turning now to FIG. 1, there is shown a schematic diagram of one example of a “smart” HUD, generally designated 20, in accordance with aspects of the present disclosure. As shown in FIG. 1, the HUD 20 is mounted to or otherwise associated with an area of a vehicle windshield W in front of the driver. In the embodiment shown, the HUD 20 includes a body 22 that houses a graphical display 26. In one embodiment, the body 22 forms a thin border around the display 26. In another embodiment, the HUD 20 may be configured with a borderless graphical display. In use, the HUD 20 displays vehicle information in graphical form in conjunction with real-time video representative of the driver's field of view from the windshield outward, as shown in FIG. 2.

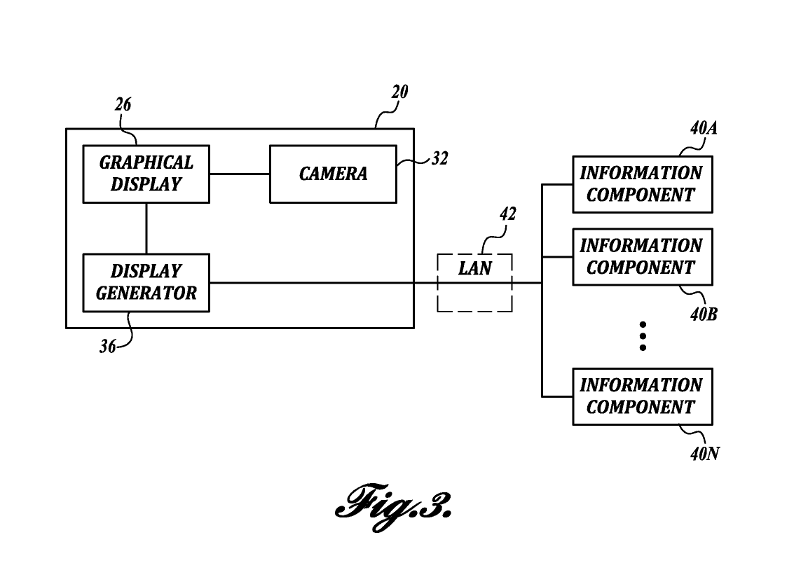

Still referring to FIG. 2, the body 22 houses the operating structure of the HUD 20. As shown in block diagrammatic form in FIG. 3, the operating structure in one embodiment includes a camera 32, a display generator 36 and the graphical display 26. The display generator 36 is connected in communication with one or more information generating or collecting components 40 (“information components 40”), such as sensors, controllers, etc. The display generator 36 can be connected directly to the one or more information components 40 or can be connected to the one or more information components 40 via a vehicle wide network 42, such as a controller area network (CAN). Those skilled in the art and others will recognize that the vehicle-wide network 42 may be implemented using any number of different communication protocols such as, but not limited to, Society of Automotive Engineers' (“SAE”) J1587, SAE J1922, SAE J1939, SAE J1708, and combinations thereof.

The vehicle information can be processed by the display generator 36 or other components so that the appropriate readings may be presented on the graphical display 26. In this regard and by way of example only, the information components 40 may report vehicle information about a number of vehicle systems, including but not limited to vehicle and engine speed, fluid levels, tire pressure monitoring, battery level, transmission and engine temperatures, collision detection system data, hybrid drive data, heating/cooling system data, infotainment data, among others. The graphical display 26 may be, for example, a liquid crystal display (LCD) or a light emitting polymer display (LPD) that may include a “touch screen” or sensitive layer configured to recognize direct input applied to the surface of the graphical display 26. For example, the position of the direct input, the pressure of the direct input, or general direction of the direct input may be recognized in order to obtain input from a vehicle operator. In other embodiments, the vehicle may include conventional operator control inputs (not illustrated) connected to the HUD 20 for obtaining input from a vehicle operator that may include, but are not limited to, buttons, switches, knobs, etc.

The display generator 36 is also connected in communication with the camera 32 or other digital image capture device. The camera 32 is configured to capture real time images and video and to transmit the captured images and video to the display generator 36. In that regard, the camera 32 can include any known image sensor, such as a CCD sensor or CMOS sensor, and associated circuitry for providing real time images and/or video to the display generator 36. In one embodiment, the camera 32 is mounted to the body 22 on the opposite side as the graphical display 26. Thus, when the HUD 20 is mounted in front of the driver, the graphical display 26 faces the vehicle driver and the camera 32 faces forwardly through the windshield W so as to capture images similar to the driver's field of view. In other embodiments, the camera 32 may be discrete from the body 22 and mounted to the vehicle in an appropriate location to capture similar forward looking views. In use, the real time images may be processed by the display generator 36 or other components so that the real time images in the form of video may be presented on the graphical display 26 in real-time or near real-time.

In accordance with an aspect of the present disclosure, the display generator 36 is configured to: (1) generate one or more graphical representations or “elements” of the vehicle information; (2) superimpose the generated graphical elements onto video obtained from the camera 32; and (3) present the graphical display 26 with the “combined” or superimposed graphical data stream in real-time or near real-time (e.g., 0.001 to 0.1 second delay, etc.) for display. As displayed, the superimposed graphical data stream provides a “see through” effect (i.e., causes the vehicle information on the display to appear to be “floating” on the camera's captured real-time image/video as if the “smart” HUD 20 is transparent.) As a result, forward visability through the windshield of the vehicle is improved.

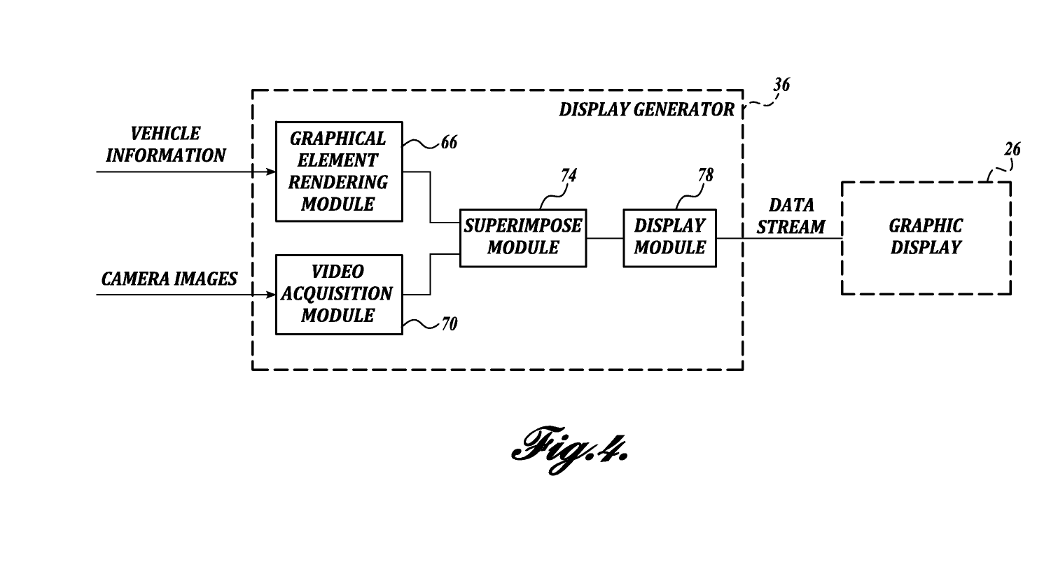

Turning now to FIG. 4, there is shown in block diagrammatic form one representative embodiment of the display generator 36 formed in accordance with an aspect of the present disclosure and capable of carrying out the functionality described above. As shown in FIG. 4, the display generator 36 includes one or more modules. In the embodiment shown, the display generator 36 includes a graphic element rendering module 66, a video acquisition module 70, a superimpose module 74, and a display module 78. While the modules are separately illustrated in the embodiment shown, it will be appreciated that the functionality carried out by each module can be combined into fewer modules or further separated into additional modules. In some embodiments, the modules of the display generator 36 contain logic rules for carrying out the functionality of the system. The logic rules in these and other embodiments can be implemented in hardware, in software, or combinations of hardware and software.

Still referring to FIG. 4, the display generator 36 includes a graphic element rendering module 66. The graphic element rendering module 66 implements logic for generating graphical elements that represent information to be presented on the graphical display 26. In particular, the module 66 causes the generation of graphical elements that convey a variety of vehicle readings. These graphical elements generated by the graphic element rendering module 66 for subsequent display by the graphical display 26 may be comprised of various objects used to convey information including, but not limited to, text, icons, images, animations, and combinations thereof. In the exemplary embodiment depicted in FIG. 2, the one or more graphical elements 80A-80B presented on the graphical display 26 are shown as a numerical representation of vehicle speed and the frequency of a local radio station tuned to by the radio. Other graphical elements may include, but are not limited to, a speedometer, a tachometer, a headlight indicator, an oil pressure gauge, an air pressure gauge, a fuel gauge, a temperature gauge, a voltmeter, a turn signal indicator, a cruise control indicator, a fuel economy indicator, and a navigation indicator, among others.

By way of example, the speed of the vehicle can be represented in graphical form in a variety of ways. In one embodiment, vehicle speed is represented graphically by a digital gauge (i.e., digital speedometer). In another embodiment, vehicle speed is represented graphically by text (e.g., a numeral, such as “53”), as shown in FIG. 2. For example, vehicle speed information may be collected by display generator 36 from an information component 40 associated with a suitable vehicle component, such as the drive shaft, the vehicle wheel, etc. The collected data is then processed so that the appropriate graphical element is rendered to reflect the speed of the vehicle. In a similar way, other vehicle information may be collected and processed in order to present any other graphical element on the graphical display 26, such as one or more of the graphical elements mentioned above.

In some embodiments, if the collected and processed vehicle information is associated with an abnormal vehicle condition, the associated graphical element may be rendered so as to be displayed with, for example, increased size, in a color indicative of an abnormal or warning condition (e.g., yellow, red, etc.) and/or flashing in one or more colors, etc. For example, if the vehicle speed information is determined to represent a vehicle speed that is greater than a speed limit set by a fleet operator or the speed limit posted roadside and provided to the HUD 20 by, for example, a GPS or navigation system, the graphical element can be generated as an enlarged numerical representation of such information. Similarly, in another embodiment, the graphical element can be generated as a flashing numerical representation of such information.

The display generator 36 also includes a video acquisition module 70. The video acquisition module 70 implements logic for obtaining real-time images or video from the camera 32. In one embodiment, the video acquisition module 70 is configured to control the operation of the camera 32. For example, in one embodiment, the video acquisition module 70 is configured to start on/off the camera, retrieve the real-time video generated by the camera or cause the camera to send the real-time video to the display generator 36, etc. During the acquisition process, the images or video received from the camera 32 can be processed and temporary stored, such as in memory and/or an associated buffer. It will be appreciated that the functionality of module 70 can be incorporated into the camera 32 in some embodiments.

The display generator 36 also includes a superimpose module 74. The superimpose module 74 implements logic for superimposing one or more graphical elements rendered by the graphic element rendering module 66 onto the real-time images or video obtained from the camera 32. As such, a data stream is generated, which contains one or more of the rendered graphical elements overlaying the captured real time video in one or more sections thereof. In the exemplary embodiment depicted in FIG. 2, the graphical display 26 includes one or more graphical elements 80A-80B positioned in a default arrangement. In some embodiments, the graphical elements may be presented at fixed locations. In other embodiments, the location of one or more graphical elements can be customized, and thus, may be moved to different locations. For example, a user in one embodiment can select any of the graphical elements displayed in a graphical display 26 and move it to another location of the graphical display 26. To arrange the graphical elements, a user in one embodiment may employ a “drag-and drop” technique in which a graphical element is selected by a stylus or user's finger, moved, and released at a desired location on the display.

As further illustrated in FIG. 4, the display generator 36 further includes a display module 78. The display module 78 implements logic for causing the superimposed data stream to be presented to the graphic display 26 for display. It will be appreciated that know image processing, buffering, and/or the like can occur at one or more of the modules 66, 70, 74, 78.

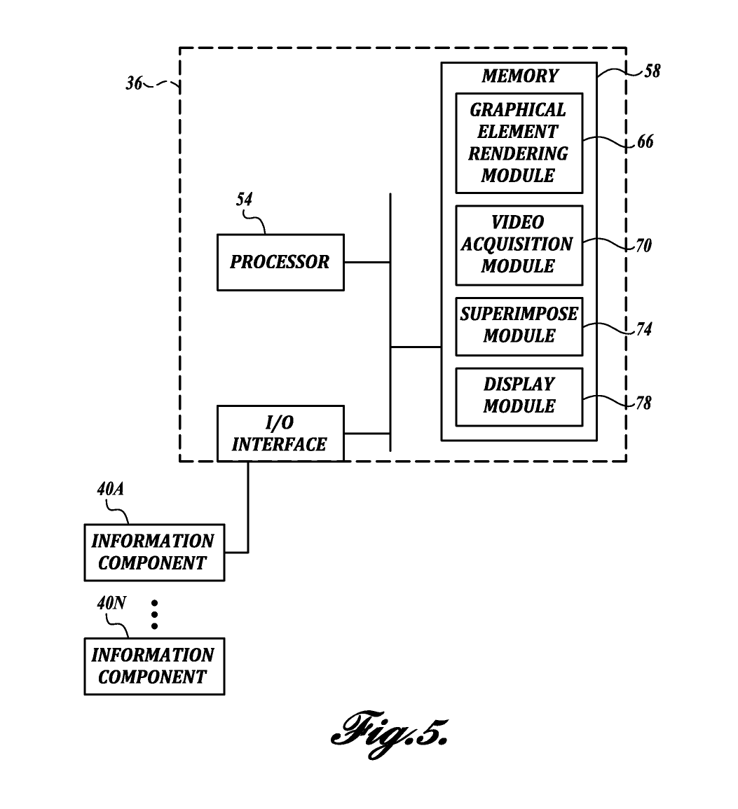

FIG. 5 illustrates another suitable embodiment of the display generator 36 in block diagrammatic form. As shown in FIG. 5, the display generator 36 includes a processor 54 and memory 58. The memory 58 may include computer readable storage media in read-only memory (ROM), random-access memory (RAM), and keep-alive memory (KAM), for example. The KAM may be used to store various operating variables or program instructions while the processor 54 is powered down. The computer-readable storage media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, instructions, programs, modules, etc. In the embodiment shown, a graphic element rendering module 66, a video acquisition module 70, a superimpose module 74, and a display module 78 are stored in memory 58. In some embodiments, the display generator 36 may include additional components including but not limited to, analog to digital (A/D) and digital to analog (D/A) circuitry, input/output circuitry and devices (I/O) and appropriate signal conditioning and buffer circuitry.

As used herein, the term processor is not limited to integrated circuits referred to in the art as a computer, but broadly refers to a microcontroller, a microcomputer, a microprocessor, a programmable logic controller, an application specific integrated circuit, other programmable circuits, combinations of the above, among others. Therefore, as used herein, the term “processor” can be used to generally describe these aforementioned components, and can be either hardware or software, or combinations thereof, that implement logic for carrying out various aspects of the present disclosure. Similarly, the term “module” can include logic that may be implemented in either hardware or software, or combinations thereof.

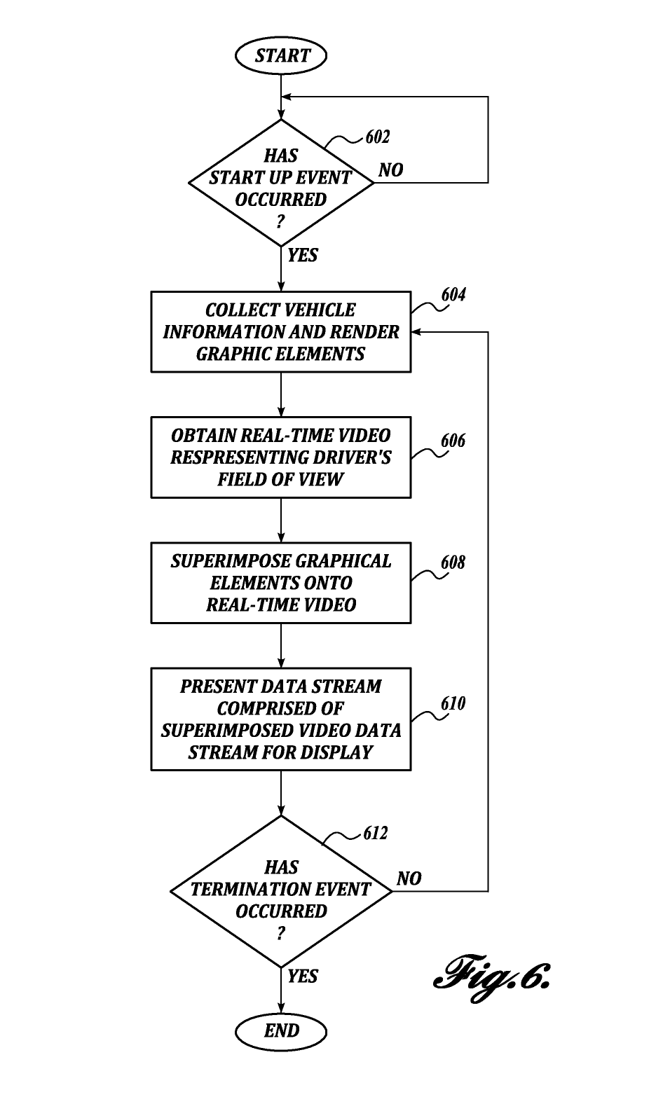

FIG. 6 is a flow diagram that depicts one exemplary embodiment of an information display method 600 formed in accordance with the disclosed subject matter. In one embodiment, the method 600 may be implemented by the modules 66, 70, 74, and 78 of the display generator 36 from either FIG. 4 or 5. Accordingly, information may be collected or otherwise received from a plurality of information components 40 and the camera 32 so that the appropriate readings and real-time video may be presented on the graphical display 26 in a superimposed manner. As a preliminary matter, those skilled in the art will appreciate that such functionality is typically designed to be carried out in a continual manner, i.e., once initialized and operating, the display generator 36 continually monitors and reports vehicle readings in conjunction with real-time video. Accordingly, the method 600 operates continually until the display generator is powered down or its operation is otherwise interrupted.

As illustrated in FIG. 6, the routine 600 begins at block 602 where a start-up event occurs that will cause graphical elements to be rendered over real-time video on the graphical display 26. Generally described, a start-up event is an event type that will cause the graphical display 26 to transition from an inactive state to an active state. By way of example only, the start-up event that occurs at block 602 may be the ignition of the vehicle's engine, which results in power being supplied to an ignition bus. Also, the graphical display 26 may be put to “sleep” in a reduced power state when the vehicle is inactive for a predetermined period of time. Thus, the start-up event may be another type of event, such as the return of the graphical display 26 from a reduced power state.

If a start event occurs at block 602, the method 600 proceeds to block 604, where the display generator 36 begins collecting information from the information components 40 and renders one or more graphical elements 80 for subsequent display. In some embodiments, the rendered graphical elements 80 can be temporarily stored in memory 58 or an associated buffer. This information may be continually collected and processed so that current readings may be conveyed on the graphical display 26. From block 604, the method proceeds to block 606, where real time video representing part of the driver's field of view captured by camera 32 is received and temporarily stored, for example, in memory 58 or an associated buffer. Next, at block 608, the rendered graphical elements from block 604 are superimposed onto the real-time video from block 606, resulting in a composite data (e.g., video) stream. The composite data stream is then presented to the display 26 at block 610 for display. Once received by the display 26, the composite data stream is rendered by display 26, as shown in the example of FIG. 2.

The method 600 then proceeds to block 612, where a determination is made as to whether a process termination event has occurred. The termination event can be turning the ignition key to the “off” position, powering down the HUD, or placing the HUD in sleep or stand-by mode, etc. If a termination event occurs at block 612, then the method 600 ends. If not, the method returns to block 604 so that a continuous feed is presented to the display 26.

It should be well understood that the routine 600 described above with reference to FIG. 6 does not show all of the functions performed when rendering the graphical elements and real-time video on a graphical display. Instead, the routine 600 describes exemplary embodiments of the disclosed subject matter. Those skilled in the art and others will recognize that some functions may be performed in a different order, omitted/added, or otherwise varied without departing from the scope of the claimed subject matter.

The principles, representative embodiments, and modes of operation of the present disclosure have been described in the foregoing description. However, aspects of the present disclosure which are intended to be protected are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure, as claimed.

1. In a vehicle having a graphical display, a method for displaying information on the graphical display, the method comprising:
providing the graphical display mounted in the vehicle so as to be partially occluding the field of view of a vehicle operator;
obtaining view data from a camera, the view data indicative of a field of view of an operator when operating the vehicle;
obtaining vehicle data; and
causing the graphical display to render the vehicle data and the view data in an overlaying manner.

2. The method of claim 1, further comprising
generating one or more graphical elements representative of the vehicle data.

3. The method of claim 1, wherein the vehicle data includes data selected from the group consisting of vehicle speed data, engine speed data, fluid level data, tire pressure data, battery level data, transmission temperature data, engine temperature data, collision detection data, hybrid drive data, heating/cooling system data, and infotainment data.

4. The method of claim 1, wherein said causing the graphical display to render the vehicle data and the view data in an overlaying manner includes
generating one or more graphical elements representative of the vehicle data, and
superimposing the generated graphical elements onto one or more predetermined sections of the view data.

5. The method of claim 4, wherein the view data includes video.

6. The system of claim 11, wherein the display generator includes:
an image acquisition module configured to collect the one or more images captured by the camera;
a graphical element rendering module configured to collect vehicle information from one or more information components and to generate the one or more graphical elements;
a superimpose module configured to generate the data stream representing the one or more graphical elements superimposed onto to the the one or more images captured by the camera;
a display module configured to cause the data stream to be presented to the graphical display for display.

7. The system of claim 6, wherein the one or more information components includes an information component selected from the group consisting of sensors, memory devices, and controllers.

8. (canceled)

9. The system of claim 6, wherein the superimpose module is further configured to arrange the one or more generated graphical elements over preselected areas of the data collected from the camera.

10. The system of claim 6, wherein the one or more generated graphical elements includes one or more object selected from a group consisting of text, an icon, an image, an animation, and combinations thereof.

11. A system for providing information to a vehicle operator, comprising:
a camera mounted in a suitable position so as to capture one or more images indicative of a field of view of a vehicle operator;
a graphical display positioned so as to occlude a section of the field of view of the vehicle operator;
a display generator coupled to the camera and to the graphical display, the display generator configured to:
receive vehicle information from one or more information components,
receive the one or more images captured by the camera;
generate one or more graphical elements indicative of the vehicle information;
generate a stream of data representing the one or more graphical elements superimposed onto the one or more images captured by the camera; and
present the stream of data to the graphical display for display.

12. The system of claim 11, wherein the display generator includes:
a memory storing one or more modules having program instructions for conveying vehicle information on the graphical display; and
a processor configured to execute the program instructions of the one or more modules to:
generate one or more graphical elements indicative of the vehicle information;
generate a stream of data composing the one or more graphical elements superimposed onto the one or more images captured by the camera; and
present the stream of data to the graphical display for display.

13. The system of claim 11, wherein the one or more information components includes an information component selected from the group consisting of sensors, memory devices, and controllers.

14. The system of claim 11, wherein the vehicle information includes information selected from the group consisting of vehicle speed data, engine speed data, fluid level data, tire pressure data, battery level data, transmission temperature data, engine temperature data, collision detection data, hybrid drive data, heating/cooling system data, and infotainment data.

15. The system of claim 11, wherein the camera, the display generator, and the graphical display are integrally formed.

16. The system of claim 11, further comprising one of a smart phone and a tablet, the said one of a smart phone and a tablet having the graphical display incorporated therein.

17. The system of claim 16, wherein the camera is incorporated into the said one of a smart phone and a tablet.

18. The system of claim 11, wherein the graphical display is housed in a body, the graphical display and the body together being non-transparent.
